(19) United States
(12) Patent Application Publication
(10) Pub. No.: US 2012/0024566 A1
(43) Pub. Date: Feb. 2, 2012

(54) HIGH-SPEED DIFFERENTIAL CABLE

(76) Inventors: Katsuo Shimosawa, Yamanashi (JP); Ken Oda, Yamanashi (JP); Osamu Arai, Saitama (JP); Takashi Wada, Yamanashi (JP); Masato Kubo, Yamanashi (JP)

(21) Appl. No.: 13/256,149

(22) PCT Filed: Mar. 10, 2010
(86) PCT No.: PCT/JP2010/054476

§ 371 Date: Sep. 12, 2011

(30) Foreign Application Priority Data
Mar. 13, 2009 (JP) 2009-061119

(51) Int. Cl. H01B 9/02

(52) U.S. Cl. 174/107

(57) ABSTRACT

A high-speed differential cable (1) comprises two-core signal lines in each of which a first dielectric layer (12) is provided around the perimeter of an internal conductor (11), which are arranged so that the cores thereof are in parallel, a second dielectric layer (13) provided around the perimeter of the two-core signal lines, drain lines (14) which are disposed outside the second dielectric layer and at both sides of the two-core signal lines, respectively, and arranged in parallel to the signal lines, an external conductor (15) which is provided longitudinally around the perimeter of the second dielectric layer and the drain lines, with the insulative side thereof arranged outside and the conductive side thereof arranged inside, a casing (16) provided around the perimeter of the external conductor, and drain line trenches (17) provided at the perimeter of the second dielectric layer, where the drain lines are disposed. In each of the drain line trenches (17), at least part of the circumference of the drain line can be engaged. Since the signal lines and the drain lines can be thereby arranged symmetrically with high precision, it is possible to ensure excellent electrical balance of the two cores of the signal lines and obtain excellent electrical property and excellent transmission property. Further, since the external conductor is provided longitudinally, it is possible to prevent the suckout of attenuation in a high frequency region.

### TECHNICAL FIELD

The present invention relates to a high-speed differential cable for performing differential transmission of signals using two-core signal lines.

### BACKGROUND ART

Conventionally, there is a high-speed differential cable as a transmission medium which is used when transmitting data at a high bit rate. Such a high-speed differential cable is disclosed in JP-A-2002-358841, having a constitution in which an insulating layer (a dielectric layer) is provided on an outer circumference of an inner conductor to form a signal line, the two signal lines are located in parallel and drain lines are arranged on both outsides thereof, an outer conductor is formed by winding, along a longitudinal direction or in a spiral manner, an aluminum-polyester tape on inside of a metal surface while keeping four-core flat structure and, an outer cover is provided on a circumference of the outer conductor. According to such high-speed differential cable, since it has a four-core flat structure in which the drain lines are arranged on both sides of the two-core signal lines, it has a high degree of flexibility as well as good assembly performance, thus handling performance of the cable is good. Further, although good transmission is obtained and is ideal if viewed from an electrical balancing of the two cores of signal lines, in a case of actually manufacturing such differential cable having a four-core flat structure, each drain line arranged on both sides of the signal lines move from the line which connects these lines and it has been extremely difficult to position the signal lines and the drain lines in parallel and flat. As a result, electrical balance is lost due to the drain lines moved from the line, thus there is a problem of degrading of characteristic impedance, etc. Moreover, in a case of winding, in a spiral manner, the aluminum polyester tape for forming an external conductor, drastic decline (referred to as suckout (dropout)) of the attenuation amount is occurred in a high-frequency range. Furthermore, in the high-speed differential cable disclosed in JP JP-A-2002-358841, the external conductor is not a perfect conductor, thus conductor potential with the potential difference between the two-core signal lines is induced on the external conductor to generate the potential difference. As a result, since current flows on the external conductor and a loss arises, the attenuation amount greatly deteriorates. Moreover, skew is large when there is a gap between the specific inductive capacity of the insulating layers.

In order to solve the various problems mentioned above, the inventors have carried out research and development. As a result, they developed a high-speed differential cable, and were able to complete the present invention. The high-speed differential cable has good handling which allows to suppress deterioration in the attenuation amount as the frequency increases, while also preventing suckout of the attenuation amount in the high-frequency range, a small amount of skew and, suppressing the degradation of characteristic impedance, etc.

### SUMMARY OF INVENTION

The present invention is made in view of the problems described above, the purpose thereof is to provide a high-speed differential cable having remarkable transmission further having good handling of the cable and a remarkable electrical property.

To achieve the purpose, the high-speed differential cable of the present invention is characterized in that two-core signal lines are arranged in parallel, a first dielectric layer being formed on an outer circumference of an inner conductor in each of the signal lines; a second dielectric layer is provided on an outer circumference of the two-core signal lines; drain lines are arranged on outside of the second dielectric layer and both sides of the two-core signal lines so as to be parallel to the signal lines; an external conductor is provided along a longitudinal direction on an outer circumference of the second dielectric layer and the drain lines, an insulating side thereof being on outer side and a conductor side thereof being on inner side; an outer cover is provided on an outer circumference of the external conductor; and drain line trenches which at least a part of circumference of the drain lines is capable of fitting in are provided on an outer circumference section of the second dielectric layer where the drain lines are arranged.

According to such constitution, it is possible to symmetrically arrange the signal lines and the drain lines in high accuracy and, this enables an electrical balance of two cores of the signal lines to be better and allows to obtain remarkable electrical property and transmission property. Moreover, since the external conductor is provided along the longitudinal direction, it is possible to prevent occurrence of a suckout of attenuation amount in a high frequency region. Moreover, since the two-core signal lines are covered by the second dielectric layer and the drain lines contact with the conductor side which is on inside of the external conductor, a conductor potential having a difference in potential between the two-core signal lines is not induced on the external conductor, as a result it is possible to suppress current generated on the external conductor and reduce loss and, it is possible to suppress deterioration in the attenuation amount. Furthermore, it is possible to enhance a binding degree of a pair of inner conductors and to reduce skew. Moreover, since the drain lines are located on both sides of the two-core signal lines, it has good handling and it is possible for a wire worker to efficiently carry out wiring work.

Moreover, it is characterized in that the drain line trenches are provided so that a central axis of fitted drain lines is located on an extended line of a line connecting central axes of the two-core signal lines. Thereby, it is possible to symmetrically arrange the signal lines and the drain lines with more accuracy and, this enables electrical balance of two cores of the signal lines and obtaining of a remarkable electrical property and transmission property.

### BRIEF DESCRIPTION OF DRAWINGS

FIG. 1 is a diagram of a high-speed differential cable concerning an embodiment of the present invention in a direction perpendicular to an axis thereof;

FIG. 2 is a diagram showing relationships between frequency and amount of attenuation of high-speed differential cables of the embodiments and a comparison example.

### DESCRIPTION OF EMBODIMENTS

The embodiments described below do not restrict the invention of the claims and, the present invention does not necessarily require all combinations of features described in the embodiments.

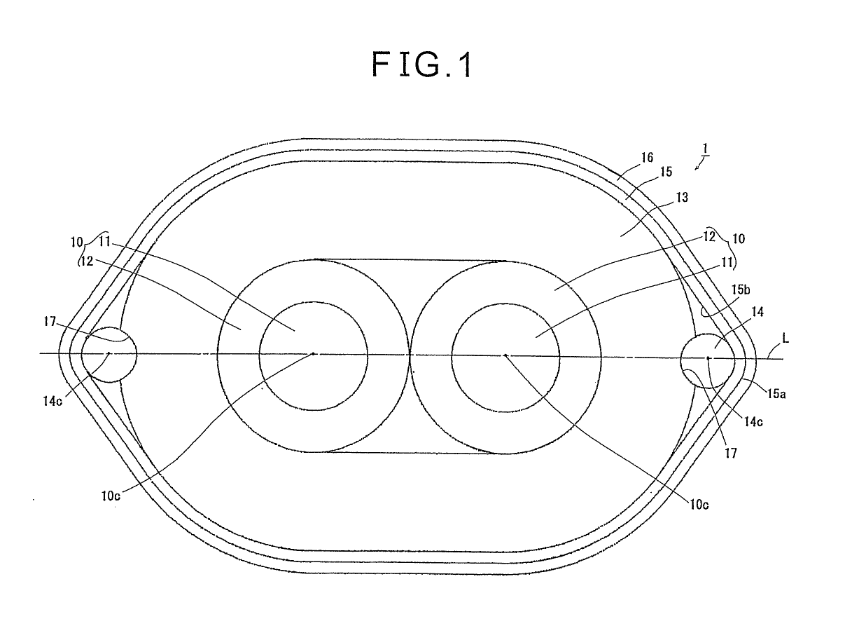

FIG. 1 is a diagram of a high-speed differential cable of the present invention in a direction perpendicular to an axis thereof. In the high-speed differential cable 1, two signal lines 10 are arranged in parallel, in each of the signal lines a first dielectric layer 12 being formed on an outer circumference of a central conductor 11 (an inner conductor) and, a second dielectric layer 13 is formed on an outer circumference of the two-core signal lines 10. When forming the second dielectric layer 13, drain line trenches 17 which at least a part of circumference of drain lines 14 is capable of fitting in is formed on outside of the second dielectric layer 13 and both sides of the two-core signal lines 10. The drain line trenches 17 is formed so that a central axis 14C of fitted drain lines 14 is located on an extended line of a line connecting central axes 10C of the two-core signal lines 10. The drain lines 14 are arranged in parallel on the drain line trenches 17 and, a shield layer (an external conductive layer) 15 is formed on an outer circumference of the second dielectric layer 13 and the drain lines 14. An insulating side of the shield layer 15 which will be described later is on the outer side and a conductor side thereof is on the inner side. Further, a jacket (outer cover) 16 is formed on an outer circumference of the shield layer 15.

For the central conductors 11, for example, silver-plated annealed copper wires may be used. For the first dielectric layer 12, for example, it may be used fluorine resin such as porous polytetrafluoroethylene (EPTFE), foamed tetrafluoroethylene- hexafluoropropylene copolymer, for example. For the second dielectric layer 13, fluorine resin such as foamed FEP, for example, may be used. For the drain lines 14, silver-plated annealed copper wires, for example, may be used. For the shield layer 15, ALPET may be used namely a metalized tape which is formed by laminating aluminum foil and polyethylene terephthalate (PET) via polyvinyl chloride (PVC) as an adhesion layer in a tape-like form. The shield layer 15 is provided along a longitudinal direction (as it is called cigarette wind) on the outer circumference so as to cover the second dielectric layer 13 and the drain lines 14, in a manner that an aluminum surface 15b which is the conductor side contacts with the second dielectric layer 13 and the drain lines 14. For the jacket 16, polyester (PE) may be used, for example.

The high-speed differential cable 1 having such structure is made by the following procedure. First, a single signal line 10 is made by winding an EPTFE tape around the outer circumference of one central conductor 11 to form the first dielectric layer 12. As a matter of course, the first dielectric layer 12 may be formed by extruding dielectric material using an extruding machine (not shown). Next, the second dielectric layer 13 having the drain line trenches 17 is formed by arranging two signal lines 10 in parallel so that the first dielectric layers 12 contact in an axial direction and, extruding the dielectric material using the extruding machine to cover so as to roll up the outer circumference of the first dielectric layers 12 of the two-core signal lines 10. Then, the shield layer 15 is formed by arranging the drain lines 14 on the drain line trenches 17 and, winding, along the longitudinal direction (cigarette wind), the metalized tape so that a PET surface thereof is outside and the aluminum surface 15b is inside and so as to roll up the outer circumference of the second dielectric layer 13 and the drain lines 14. Finally, the jacket 16 is formed by winding an insulating tape on the outer circumference of the shield layer 15 or extruding the dielectric material to the outer circumference of the shield layer 15 using the extruding machine to cover. According to the procedure described above, the high-speed differential cable is completed.

According to the high-speed differential cable 1 having above-mentioned structure, it is possible to symmetrically arrange the signal lines 10 and the drain lines 14 in high accuracy and, this enables an electrical balance of the two cores of the signal lines 10 to be better and allows to obtain remarkable electrical property and transmission property. Moreover, since the shield layer 15 is provided along the longitudinal direction, it is possible to prevent suckout of attenuation in a high frequency region. Moreover, the two-core signal lines 10 are covered by the second dielectric layer 13 and, the drain lines 14 contact with the aluminum surface 15b which is on inside of the shield layer 15. For this reason, a conductor potential having difference in potential between the two-core signal lines 10 is not induced on the shield layer 15, thus it is possible to suppress current generated on the shield layer 15, reduce a loss, and it is possible to suppress deterioration in the attenuation amount. Furthermore, it is possible to enhance a binding degree of a pair of central conductors 11 and to reduce a skew. Moreover, since the drain lines 14 are located on both sides of the two-core signal lines 10, it has a high degree of flexibility as well as good assembly performance, thus it has good handling performance and it is possible to enhance an efficiency of a wiring operation.

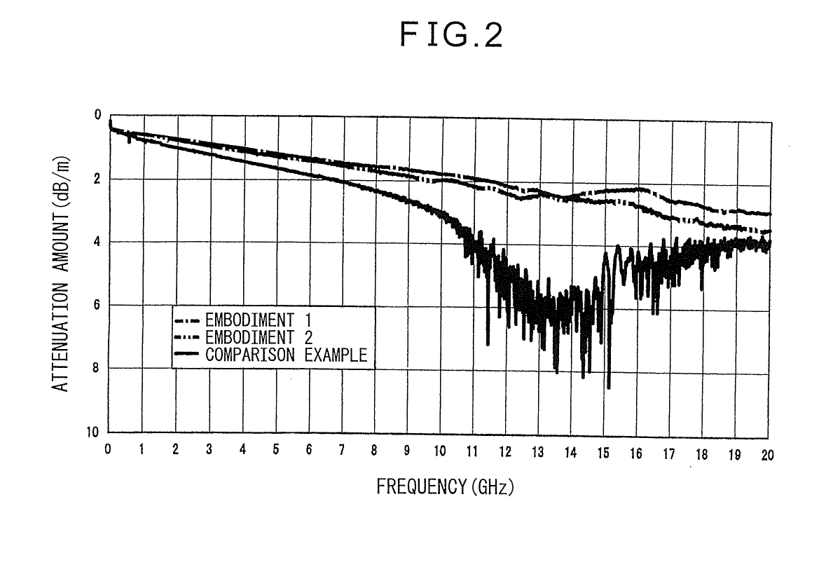

Next, a measurement result will be explained referring to FIG. 2, where we made high-speed differential cables 1 of this embodiment as embodiments 1 and 2 and, a conventional high-speed differential cable as a comparison example and, measured the attenuation amount and the skew of them. The high-speed differential cable 1 of the embodiment 1, which has been used in the measurement, is made as follows. A silver-plated annealed copper wire with external diameter 0.511 mm is prepared as the central conductor 11 and, the first dielectric layer 12 is formed by winding a porous PTFE tape on the outer circumference of the central conductor 11 so as to have an external diameter of 0.9 mm, thereby being the signal line 10. The second dielectric layer 13 is formed by arranging two signal lines 10 in parallel so that the first dielectric layers 12 contact in the axial direction and, covering the outer circumference of the first dielectric layers 12 of the two signal lines 10 with foamed FEP so as to roll up it and have a thickness of 0.45 mm.

Then, the shield layer 15 is formed by arranging silver-plated annealed copper wires with external diameter 0.254 mm as the drain lines 14 in parallel on the drain line trenches 17 and, winding, along the longitudinal direction, the ALPET which is made by laminating the aluminum film with thickness 10 μm and the PET with thickness 12 μm via the PVC (adhesion layer) with thickness 2-3 μm so as to roll up the outer circumference of the second dielectric layer 13 and drain lines 14 and so that the aluminum surface 15b coheres. Finally, the jacket 16 is formed by winding the PE tape with thickness 0.008 mm so as to roll up the outer circumference of the shield layer 15. Moreover, the high-speed differential cable 1 of the embodiment 2, which has been used in the measurement, has the same structure, in comparison with the high-speed differential cable 1 of the embodiment 1, other than matters that the first dielectric layer 12 is formed by the foamed FEP and the second dielectric layer 13 is formed in thickness 0.5 mm.

On the other hand, the high-speed differential cable of the comparison example, which has been used in the measurement, is made as follows. A silver-plated annealed copper wire with external diameter 0.511 mm is prepared as a central conductor and, a dielectric layer is formed by winding the porous PTFE tape on the outer circumference of the central conductor so as to be external diameter 1.25 mm, thereby being the signal line. The shield layer is formed by arranging two signal lines 10 in parallel so that the dielectric layers contact in the axial direction and, winding, in a spiral manner (as it is called spiral wind), the ALPET which is made by laminating the aluminum film with thickness 10 μm and the PET with thickness 12 μm via the PVC (adhesion layer) with thickness 2-3 μm so as to roll up the outer circumference of the dielectric layer of the two signal lines and so that the PET surface 15b coheres. Silver-plated annealed copper wire with external diameter 0.254 mm is arranged in parallel as the drain line on one side of the signal lines and on an outer side of the shield layer and, finally, a jacket is formed by covering with the FEP so as to roll up the outer circumference of the shield layer and the drain line and have a thickness 0.05 mm.

FIG. 2 is a diagram which shows a change of the attenuation amount (dB/m) when changing frequency (GHz) from 0 to 20 GHz with respect to the high-speed differential cables 1 of the embodiments 1, 2 and the high-speed differential cable of the comparison example. As is clear from FIG. 2, it is possible to prevent the suckout of the high-speed differential cables 1 of the embodiments 1 and 2, whereas the suckout occurs in a range where the frequency is 11 to 16 GHz for the high-speed differential cable of the comparison example.

Moreover, when the frequencies are 1.0 GHz, 2.0 GHz, 3.125 GHz, 5.0 GHz and 6.0 GHz, whereas the attenuation amounts of the high-speed differential cable of the comparison example are 0.757 dB/m, 1.001 dB/m, 1.221 dB/m, 1.653 dB/m and 1.845 dB/m respectively, the attenuation amounts of the high-speed differential cable 1 of the embodiment 1 are 0.603 dB/m, 0.732 dB/m, 0.887 dB/m, 1.164 dB/m and 1.311 dB/m respectively and, the attenuation amounts of the high-speed differential cable 1 of the embodiment 2 are 0.586 dB/m, 0.758 dB/m, 0.967 dB/m, 1.262 dB/m and 1.389 dB/m respectively, thus it is possible to suppress deterioration in the attenuation amount of the high-speed differential cable 1 of the embodiments 1, 2 in comparison with the high-speed differential cable of the comparison example. Moreover, the skew of the high-speed differential cable 1 of the embodiment 1 is 2 ps/10 m, whereas the skew of the high-speed differential cable 1 of the comparison example is 9.0 ps/10 m, thus it is possible to reduce the skew.

### INDUSTRIAL APPLICABILITY

The high-speed differential cable of the present invention can be applied to a device which performs a long-distance data transmission at a high bit rate, for example to an electronic device such as a computer, a calculator, a cell phone, and it can be also applied to a control device for an automobile, an airplane and the like.

1. A high-speed differential cable in which
two-core signal lines are arranged in parallel, a first dielectric layer being formed on an outer circumference of an inner conductor in each of the signal lines;
a second dielectric layer is provided on an outer circumference of the two-core signal lines;
drain lines are arranged on outside of the second dielectric layer and along both sides of the two-core signal lines so as to be parallel to the signal lines;
an external conductor is provided along a longitudinal direction on an outer circumference of the second dielectric layer and the drain lines, an insulating side thereof being on outer side and a conductor side thereof being on inner side;
an outer cover is provided on an outer circumference of the external conductor; and
drain line trenches which at least a part of circumference of the drain lines is capable of fitting in are provided on an outer circumference section of the second dielectric layer where the drain lines are arranged.

2. A high-speed differential cable according to claim 1, wherein the drain line trenches are provided so that each central axis of fitted drain lines is located on an extended line of a line connecting central axes of the two-core signal lines.
